(19) United States
(12) Patent Application Publication
(10) Pub. No.: US 2006/0199570 A1
(43) Pub. Date: Sep. 7, 2006

(54) Providing caller-selected information to a receiving device

(76) Inventor: Vlad Vendrow, Redwood Shores, CA (US)

Correspondence Address: FISH & RICHARDSON P.C., PO BOX 1022, MINNEAPOLIS, MN, 55440-1022, US

(21) Appl. No.: 11/070,779

(22) Filed: Mar. 1, 2005

(51) Int. Cl. H04M 3/42

(52) U.S. Cl. 455/415

(57) ABSTRACT

Methods and systems are described for providing caller-selected information to a receiving device, where the caller-selected information is selected by a caller before a call is placed.

### BACKGROUND

The present invention relates to communications systems.

Ringtone personalization is a feature available for mobile phones users. Ringtones can be configured in an address book on a receiving device (e.g., a cell phone) and are based on a caller's Caller ID. A user can choose and assign individual ringtones to specific callers. When a caller places a call to the user's receiving device, the receiving device uses Caller ID to search the address book for the caller and retrieves the assigned ringtone. The assigned ringtone is then played by the receiving device to notify the user that the caller is placing a call to the receiving device.

Call screening applications, which typically are offered by service providers, allow call recipients to screen incoming calls. When a caller places a call, an automated answering system invites the caller to speak his/her name, and the caller stays on the line while the system connects the call to a receiving device. A recording of the caller's name can be passed to the receiving device for presentation to the user of the receiving device. If the user of the receiving device decides to accept the call, the user is connected to the caller. Typically, the caller speaks his/her name every time he/she places a call, and the receiving device's automated answering system answers the call to record the caller's name.

### SUMMARY

Methods and systems are described for providing caller-selected information to a receiving device, where the caller-selected information is selected by a caller before a call is placed.

The methods and systems can be implemented to realize one or more of the following advantages. A caller has control over what information will be provided to a receiving device when a call is placed to the device. The caller can choose different information for different receiving devices. The system is compatible with existing caller ID systems.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram of a caller identification system.

FIG. 2 is a block diagram of a caller identification storage.

FIG. 3 is a flow chart for processing a call when caller-selected information is passed from the caller's device to the receiving device.

FIG. 4 is a flow chart for processing a call when caller-selected information is retrieved from storage by the receiving device.

Like reference numbers and designations in the various drawings indicate like elements.

### DETAILED DESCRIPTION

This application describes methods and systems that allow a caller to select information (e.g., a ring-tone) that will be provided to a receiving device when a call is placed to the receiving device. The caller can select the information before placing a call. For example, a caller can store a recording of their name before placing a call. The recording can be passed during the call initiation phase to every receiving device to which a call is placed. The recording can be played back by the receiving device as a ring-tone.

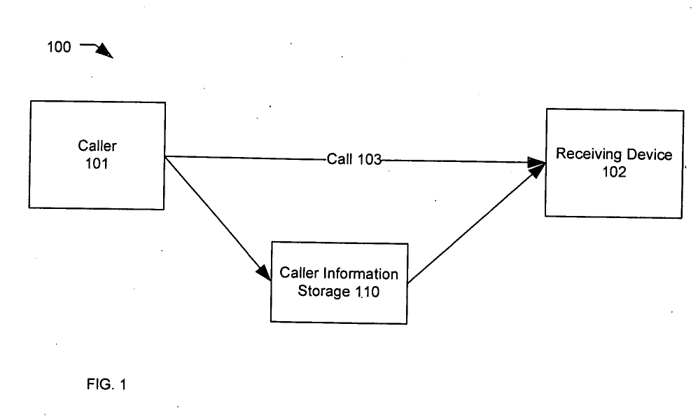

As shown in FIG. 1, a caller information system 100 integrates several different communications media to allow a caller 101 to prepare and provide caller-selected information to a receiving device 102. Receiving device 102 can be a wireless (e.g., cellular) phone, a voice-over-internet phone, or a computer-based phone.

Caller information system 100 includes storage 110 that can store caller-selected information of various types, content, and communications media. Examples of caller-selected information include voice recordings, music, video clips, pictures, text, and data.

A device that caller 101 uses to place a call can be capable of creating and selecting the user-selected information. The device can copy the user-selected information from some other source. The device that caller 101 uses can be capable of sending the user-selected information to receiving device 102 during a call or when placing a call.

Alternatively, caller 101 can select information using a device or service (e.g., an online service) other than the device that caller 101 uses to place the call.

Receiving device 102 can receive caller-selected information from the caller's device. Alternatively, receiving device 102 can receive caller-selected information from storage 110. Storage 110 can be accessible over the internet, a wireless connection, or some other communications means. Receiving device 102 can display the caller-selected information on a screen (e.g., an LCD screen on a cellular phone), audibly present the caller-selected information, or present the caller-selected information to a user of the receiving device by some other available means (e.g., vibration, changing color, etc.).

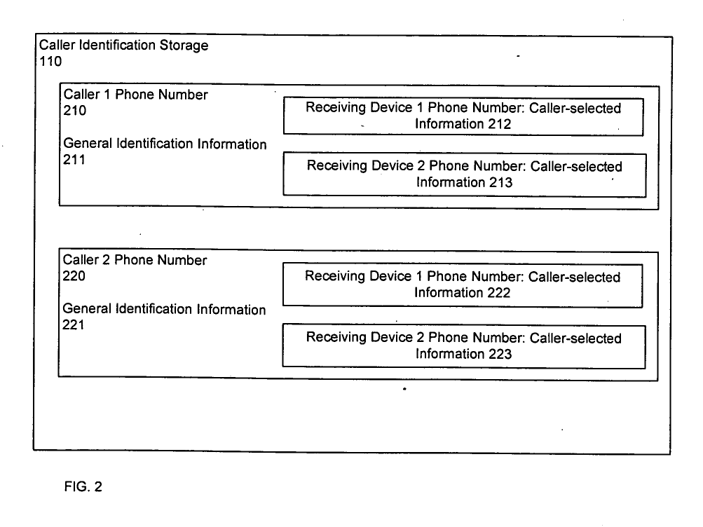

FIG. 2 illustrates one implementation of an architecture for storage 110. Storage 110 can contain information about a single caller 210 if storage 110 is located on a single user device (e.g., phone address book) or about multiple callers 210 and 220 if storage 110 resides on a server (e.g., a server provided by a service provider). Storage 110 can be organized to store records for caller 210 with general identification information 211. In addition, a caller can select different information for specific receiving devices (212 and 213).

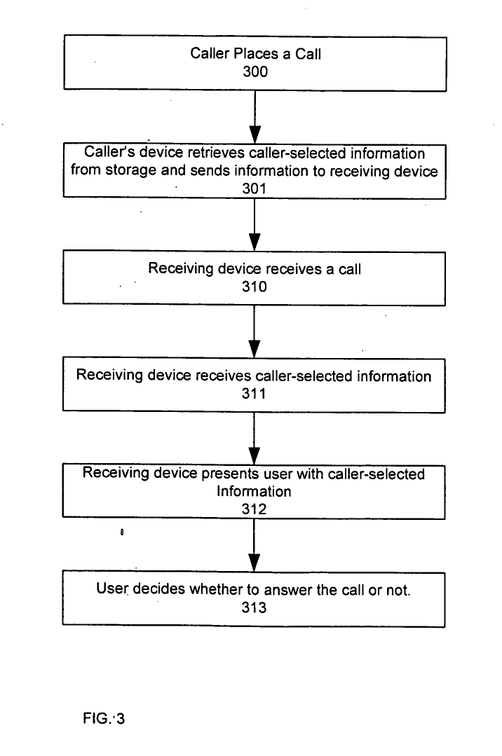

FIG. 3 is a call-progress flowchart for the case in which a device used by a caller can send caller-selected information to a receiving device. When the caller places a call (step 300), the caller's device retrieves or identifies the caller-selected information (which can be either general information or information specific for this receiving device) from storage and sends it to the receiving device (step 301). When the receiving device receives a call (step 310), the receiving device also receives the caller-selected information (step 311) and presents the information to a user (step 312). The user can decide whether answer the call or not (step 313).

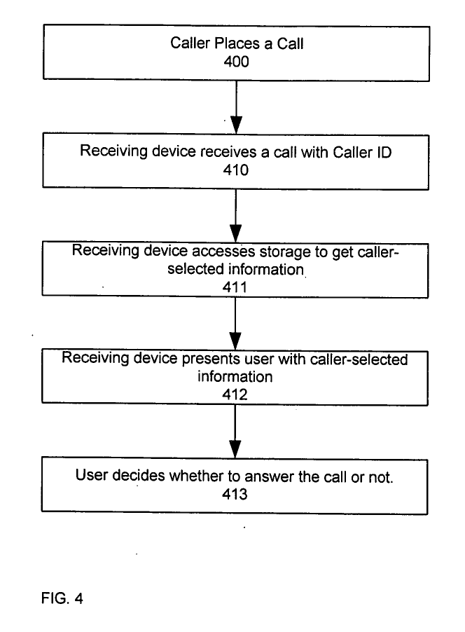

FIG. 4 is a call progress flowchart for the case in which caller-selected information is retrieved by a receiving device from server-based storage. The caller-selected information can be selected and stored on the server-based storage before a caller places a call. When the caller places the call (step 400), the receiving device receives Caller ID information (step 410). Caller ID information is information identifying the caller, e.g., the caller's phone number. The receiving device can use the Caller ID information and the phone number of the receiving device to request caller-selected information from storage (step 411).

If caller-selected information is received from the storage, the receiving device can present the caller-selected information to a user (step 412), and the user can decide whether to answer the call or not (step 413).

Caller-selected information can be provided to cellular phones using an internet connection, which is available on many cellular phones today. In one implementation, when a call with accompanying Caller ID information is received by a cellular phone, the receiving cellular phone can use the internet connection to communicate with a service provider and retrieve caller-selected information using the Caller ID. For example, the receiving cellular phone can access a web site of the service provider and pass the Caller ID as a parameter. The service provider can serve a dynamically-generated web page that can be displayed on an LCD of the receiving cellular phone. The dynamically-generated web page can include a picture of the caller and/or caller-selected audio for playback on the receiving cellular phone.

Internet-protocol (IP) phones typically use a signaling protocol to establish calls over an internet connection. Signaling protocols typically provide the capability to add custom information to call control commands. For example, the INVITE command of the SIP protocol, which notifies a receiving IP phone of an incoming call, can contain additional data. The additional data can be, for example, a ringtone that is sent by the caller. The receiving IP phone can extract and audibly play the ringtone.

The invention and all of the functional operations described herein can be implemented in digital electronic circuitry, or in hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, multiple computers, a cellular phone, or a personal digital assistant (PDA). A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one device or on multiple devices at one site or distributed across multiple sites and interconnected by a communication network.

Method steps of the invention can be performed by one or more programmable processors executing a program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a program include, by way of example, both general and special purpose microprocessors, and any one or more processors of any kind of digital computer, cellular phone, or PDA. Generally, a processor will receive instructions and data from a read-only memory or a random access memory or both.

The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

Although the use of caller-selected information has been described primarily in the context of voice communication, caller-selected information can also be used with other forms of communication between devices. For example, the sender of a text or data message (e.g., a short message service message) can select information before creating or before sending the message that can be provided to, or be retrieved by, a device that receives the message.

What is claimed is:

1. A method comprising:
providing caller-selected information to a receiving device, where the caller-selected information is selected by a caller before a call is placed.

2. The method of claim 1, wherein the caller-selected information is automatically provided to the receiving device when the call is placed.

3. The method of claim 1, wherein the caller-selected information is selected using a device which the caller uses to place the call.

4. The method of claim 1, wherein the caller-selected information is selected using an online service.

5. The method of claim 1, wherein providing includes pushing the caller-selected information from a device which the caller uses to place the call to the receiving device.

6. The method of claim 1, wherein providing includes pushing the caller-selected information from a storage device to the receiving device.

7. The method of claim 1, wherein providing includes requesting the caller-selected information from a device which the caller uses to place the call.

8. The method of claim 1, wherein providing includes requesting the caller-selected information from a storage device.
